(19) United States
(12) Patent Application Publication
(10) Pub. No.: US 2006/0001606 A1
(43) Pub. Date: Jan. 5, 2006

(54) Plasma display device and driving method thereof

(76) Inventor: Sang-Hoon Yim, Suwon-si (KR)

Correspondence Address: CHRISTIE, PARKER & HALE, LLP, PO BOX 7068, PASADENA, CA, 91109-7068, US

(21) Appl. No.: 11/154,051

(22) Filed: Jun. 15, 2005

(30) Foreign Application Priority Data
Jun. 30, 2004 (KR) 10-2004-0050884

(51) Int. Cl. G09G 3/28

(52) U.S. Cl. 345/63

(57) ABSTRACT

A plasma display device of the present invention includes X and Y electrodes applied with a sustain pulse, an M electrode formed between the X and Y electrodes, and an address electrode crossing the X, Y, and M electrodes. For driving such a plasma display device, after applying a reset waveform to the M electrode so as to convert every cell to an on state, an erase scan pulse and an erase address pulse are selectively applied to the M electrode and address electrode so as to convert a cell of an on state to an off state. Subsequently, a sustain pulse is alternately applied to the X and Y electrodes, such that a sustain discharge is generated in cells remaining in the on state and not in cells converted to the off state.

### CROSS-REFERENCE TO RELATED APPLICATIONS

This application claims priority to and the benefit of Korean Patent Application No. 10-2004-0050884 filed in the Korean Intellectual Property Office on Jun. 30, 2004, the entire content of which is incorporated herein by reference.

### BACKGROUND OF THE INVENTION

1. Field of the Invention

The present invention relates to a plasma display device and a driving method thereof.

2. Description of the Related Art

A plasma display device is a flat panel display that uses plasma generated by gas discharge to display characters or images. It includes a plasma display panel (PDP) and peripheral circuits. The PDP includes, depending on its size, more than several scores to millions of pixels arranged in a matrix pattern.

Such a PDP is classified as a direct current (DC) type or an alternating current (AC) type according to its discharge cell structure and the waveform of the driving voltage applied thereto.

The DC PDP has electrodes exposed to a discharge space, and accordingly, it allows a DC to flow through the discharge space while a voltage is applied. Therefore, such a DC PDP problematically requires resistance for limiting the current. On the other hand, the AC PDP has electrodes covered with a dielectric layer that forms a capacitor to limit the current and protects the electrodes from the impact of ions during discharge. Accordingly, the AC PDP has a longer lifetime than the DC PDP.

FIG. 1 is an electrode arrangement diagram for a conventional plasma display panel. Electrodes of a conventional plasma display panel are arranged in an n×m matrix format and in a three-electrode structure including an address electrode, a scan electrode, and a sustain electrode.

In more detail, a conventional AC PDP includes a plurality of address electrodes A₁ to Aₘ arranged in a column direction, a plurality of sustain electrodes X₁ to Xₙ arranged in a row direction, and a plurality of scan electrodes Y₁ to Yₙ also arranged in a row direction.

Each frame of the plasma display device is divided into a plurality of subfields, and each subfield includes a reset period, an address period, and a sustain period. The reset period is for initializing the state of each discharge cell so as to facilitate an addressing operation on the discharge cell. During the reset period, a gently increasing waveform is applied to the scan electrode so as to form wall charges by discharging every cell, and then a gently decreasing waveform is applied to the scan electrode so as to form appropriate wall charges or remove wall charges depending on the state of each cell.

The address period (which is also called a scan period or a writing period) is for setting the state of each cell in a panel to be in a turned-on or turned-off state. Wall charges are accumulated in the turned-on cells (i.e., addressed cells). The sustain period is for causing a discharge for displaying an image based on the addressed cells.

However, according to the above-described driving method, every subfield includes a reset period, and therefore every subfield produces a light (hereinafter called a “reset light”) caused by the discharge of the reset period. Therefore, according to the conventional driving method, contrast is problematically deteriorated because every subfield produces the reset light.

In order to resolve such a problem, a driving method in which a reset period is performed in only one subfield has been proposed. According to such a proposed driving method, a discharge is generated in every cell in the reset period so as to form an on-state (i.e., a state in which a cell may immediately discharge upon application of a sustain pulse) in the cells, and then an erase address pulse (i.e., a pulse to convert a wall charge state to an off-state) is selectively applied during the address period. Hereinafter, a driving method wherein such an erase address pulse is applied during the address period is called a ‘clear’ driving method.

FIG. 2 illustrates a clear driving waveform disclosed in U.S. Pat. No. 6,495,968.

In FIG. 2, RPy denotes a reset pulse for initializing a state of a discharge cell before an address operation. In addition, DPi and SP, respectively, denote an address pulse and a scan pulse, and due to the address pulse DPi and the scan pulse SP, the address electrode and the Y electrode respectively gather negative and positive wall charges.

Referring to FIG. 2, a discharge may be expected to be generated by voltages IPx of the X electrode, however, when positive wall charges are accumulated on the Y electrode by an address pulse and a scan pulse, the positive wall charges block the discharge even if the voltages IPx are applied.

That is, according to a conventional clear driving method shown in FIG. 2, every cell is turned to an on-state by applying a reset pulse, and then required cells are turned to an off-state by selectively applying an address pulse and a scan pulse.

According to the conventional clear driving method shown in FIG. 2, different waveforms are applied to the Y and X electrodes since the X electrode is applied with only the sustain pulse IPx, but the Y electrode is applied with the reset pulse RPy, the scan pulse SP, and the like as well as the sustain pulse. Therefore, a driving circuit for driving the Y electrode is different from that for driving the X electrode, and impedances of driving circuits for X and Y electrodes may not match each other. In this case, discharge may become faulty since a waveform alternately applied to the X and Y electrodes may be distorted in the sustain discharge period.

### SUMMARY OF THE INVENTION

The embodiments of the invention provide a driving method having enhanced contrast and a plasma display device and a driving method that prevent faulty discharge.

An exemplary driving method of a plasma display device according to one embodiment of the present invention is for driving a plasma display device including at least one first electrode and at least one second electrode that each have a sustain pulse applied to them. The plasma device includes at least one third electrode formed between the first and second electrodes, and at least one fourth electrode crossing the first, second, and third electrodes. According to such a driving method, a reset waveform is applied to the third electrode during a first period. The reset waveform converts every cell to an on state. An address operation is performed by selectively applying a first pulse and a second pulse to the third electrode and the fourth electrode, for converting an on-cell formed by the reset waveform to an off-cell. In addition, a sustain discharge operation is performed on cells on which the first and second pulses are not applied, by applying a sustain pulse to the first and the second electrodes of each cell.

In a further embodiment, the plasma display device is driven using frames including a plurality of subfields, where a first period is included in only one subfield among the plurality of subfields.

In another further embodiment, the plasma display device is driven by using frames including a plurality of subfields, where the first period is a part of a chronologically first subfield among the plurality of subfields.

In another further embodiment, the address operation and the sustain discharge are performed in separated periods for each cell.

In another further embodiment, the first, second, third, and fourth electrodes are respectively provided as a group, wherein a discharge cell is formed by a set of corresponding first, second, third, and fourth electrodes. In this case, an address operation is performed in a j-th discharge cell by applying a first pulse to the third electrode of the j-th discharge cell. A sustain operation is performed in an m-th discharge cell by applying a sustain pulse to the first or second electrode of the m-th discharge cell. The first pulse may be applied between periods for applying the sustain pulse to the first electrode and the second electrode.

In another further embodiment, the third electrode is formed between the first electrode and the second electrode.

Another exemplary driving method of a plasma display device according to an embodiment of the present invention is for driving a plasma display device including at least one first electrode and at least one second electrode each applied with a sustain pulse, at least one third electrode formed running in the same direction as the first and second electrodes, and at least one fourth electrode crossing the first, second, and third electrodes, wherein the plasma display device is driven by a frame including a plurality of subfields that includes a first and second subfields. According to such a driving method, in the first subfield, the following steps are executed. A reset waveform is applied to the at least one third electrode during a first period, for converting every cell to an on state. An address operation is performed by selectively applying a first pulse and a second pulse to the third electrode and the fourth electrode, for converting an on-cell formed by the reset waveform to an off-cell. Furthermore, a sustain discharge operation is performed at cells not applied with the first and second pulses, by applying a sustain pulse to the first and the second electrodes. In the second subfield of the exemplary driving method, the following steps are executed. An address operation is performed by selectively applying the first and second pulses to the third and fourth electrodes, for converting an on-cell formed by the reset waveform to an off-cell. In addition, a sustain discharge operation is performed on cells where the first and second pulses are not applied by applying a sustain pulse to the first and the second electrodes.

In a further embodiment, in the first subfield, the address operation and the sustain discharge are performed in separated periods for each cell.

In another further embodiment, the first, second, third, and fourth electrodes are respectively provided as a plurality, wherein a discharge cell is formed by a set of corresponding first, second, third, and fourth electrodes, while an address operation is performed in a j-th discharge cell by applying a first pulse to the third electrode of the j-th discharge cell and, a sustain operation is performed in an m-th discharge cell by applying a sustain pulse to the first or second electrode of the m-th discharge cell.

An exemplary plasma display device according to an embodiment of the present invention includes a plasma display panel, an address driver, an X electrode driver, a Y electrode driver, an M electrode driver, and a controller. The plasma display panel includes X and Y electrodes applied with a sustain discharge voltage pulse, an M electrode formed running in the same direction as the X and Y electrodes, and an address electrode insulated from and crossing the X, Y, and M electrodes. The address driver applies a display data signal for turning off a discharge cell through the address electrode. The X electrode driver and the Y electrode driver respectively apply a sustain discharge voltage pulse to the X and Y electrodes, for performing a sustain discharge operation. The M electrode driver applies a reset waveform for enabling an on state of every cell to the M electrode while the sustain pulse is applied to the X and Y electrodes. The controller supplies a control signal to the address driver, the X electrode driver, the Y electrode driver, and the M electrode driver.

In a further embodiment, the M electrode driver applies an erase scan pulse for converting a cell from the on state to an off state.

In a still further embodiment, the M electrode driver applies the reset waveform for enabling an on state for every cell to the M electrode during the first period, and the address driver and the M electrode driver selectively apply the erase address pulse and the erase scan pulse to the address electrode and the M electrode, respectively, for converting an on-cell formed by the reset waveform to an off-cell.

In this case, the plasma display device may be driven using a frame including a plurality of subfields. The first period is a part of the first subfield among the plurality of subfields.

### BRIEF DESCRIPTION OF THE DRAWINGS

FIG. 1 is an electrode arrangement diagram for a conventional PDP.

FIG. 2 is a timing diagram illustrating a conventional driving method for a PDP.

FIG. 3 is an electrode arrangement diagram for a PDP according to an embodiment of the present invention.

FIG. 4 is a perspective exploded view of one embodiment of a PDP panel.

FIG. 5 is a sectional view of a PDP according to an embodiment of the present invention.

FIG. 6 is a timing diagram of one embodiment of a process for driving a PDP according to a first embodiment of the present invention.

FIG. 7 is a timing diagram of one embodiment of a process for driving a PDP according to a first embodiment of the present invention.

FIG. 8 is a diagram illustrating a PDP according to one embodiment of the present invention.

FIG. 9 is a timing diagram of one embodiment of a process for driving a PDP according to a second embodiment of the present invention.

FIG. 10 is a timing diagram of one embodiment of a process for driving a PDP according to a second embodiment of the present invention.

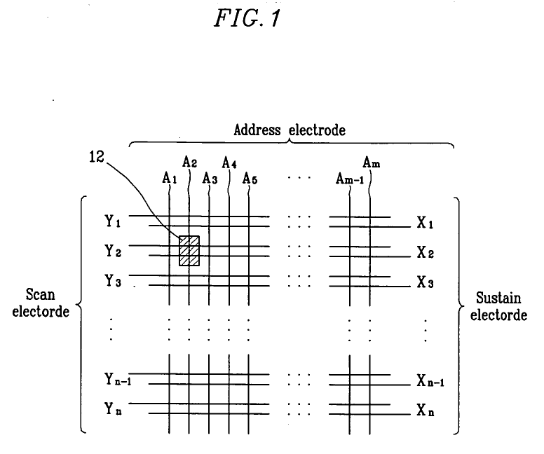

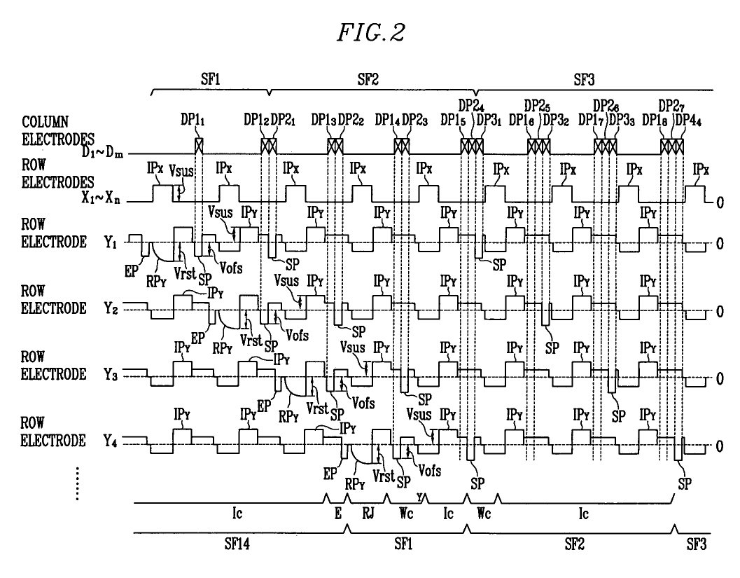

### DETAILED DESCRIPTION

An “on-cell” in a PDP may refer to a cell that performs a sustain discharge operation when a sustain pulse is applied, and an “off-cell” may refer to a cell that does not perform a sustain discharge operation when a sustain pulse is applied.

In addition, “erase address pulse” and “erase scan pulse” respectively may refer to a pulse applied to an address electrode and a scan electrode (or a middle electrode) so as to convert an on-cell to an off-cell.

In addition, “clear driving” may refer to a driving method wherein every cell is turned to an on state, and then an erase address pulse or an erase scan pulse is selectively applied so as to convert the on-cell to an off state.

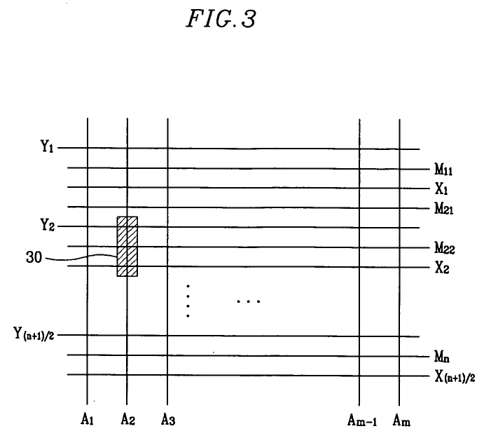

FIG. 3 is an electrode arrangement diagram of a PDP according to an embodiment of the present invention. As shown in FIG. 3, in a plasma display device according to an embodiment of the present invention, a plurality of address electrodes A₁-Aₘ are arranged in parallel in a column direction. A plurality of Y electrodes Y₁-Y_{(n+1)/2}, a plurality of X₁-X_{(n+1)/2}, and a plurality of middle electrodes (M electrodes) M₁-Mₙ are arranged in a row direction. That is, according to an embodiment of the present invention, an M electrode is arranged between Y and X electrodes, and the PDP has a four electrode structure wherein the four electrodes include Y, X, M, and address electrodes, which partially define a discharge cell 30.

According to an embodiment of the present invention, the X and Y electrodes are electrodes for receiving a sustain pulse, and the M electrode is an electrode for receiving a reset waveform and a scan pulse.

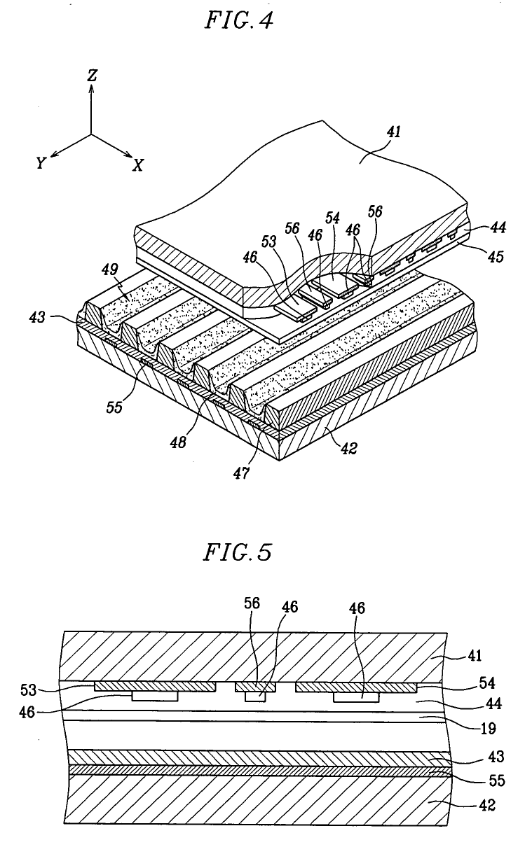

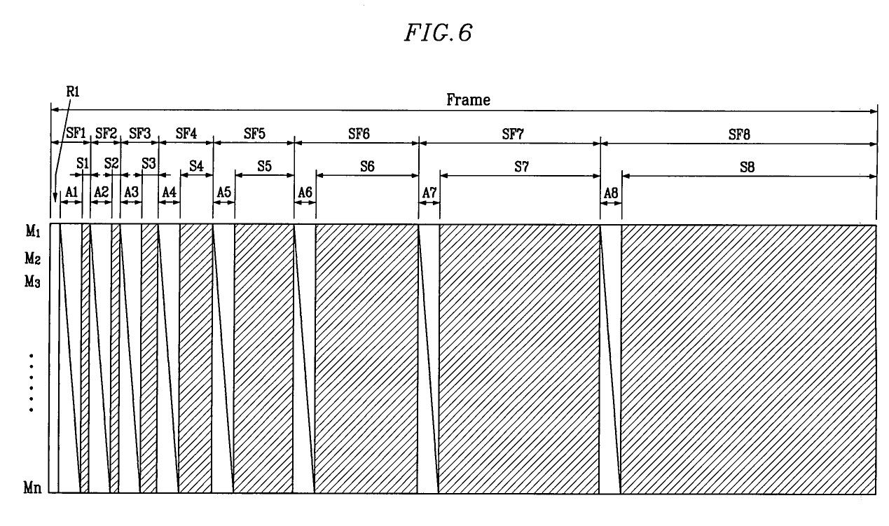

FIG. 4 is a perspective view of a PDP according to an embodiment of the present invention, and FIG. 5 is a sectional view of the PDP shown in FIG. 4. Referring to FIG. 4 and FIG. 5, a PDP according to an embodiment of the present invention includes a first substrate 41 and a second substrate 42. An X electrode 53 and a Y electrode 54 are formed on the first substrate 41. In addition, bus electrodes 46 are formed on the X and Y electrodes 53 and 54. A dielectric layer 44 and a protective layer 45 are consecutively formed over the X and Y electrodes 53 and 54.

Address electrodes 55 are formed on the surface of the second substrate 42, and a dielectric layer 43 is formed on the address electrodes 55. Barrier ribs 47 are formed on the dielectric layer 43 to thereby form cells 49 which are discharge spaces between the barrier ribs 47. Phosphor 48 is coated on the surface of the barrier rib 47 in the cell space between the barrier ribs 47. The X and Y electrodes 53 and 54 are formed perpendicular to the address electrode 55.

According to an embodiment of the present invention, an M electrode 56 is formed between a pair of the X and Y electrodes 53 and 54 that are formed on the surface of the first substrate 41. As described above, a reset waveform and a scan pulse are applied to the M electrode. A bus electrode 46 is formed on the M electrode 56.

M electrodes are provided between the Xᵢ and Yᵢ electrodes and between the Yᵢ and Xᵢ₊₁ electrodes in the PDP according to an embodiment of the present invention. That is, M electrodes are can be identified by a number n when X and Y electrodes are respectively identified by a number (n+1)/2. However, it is notable that the M electrodes 56 may be provided only between the Xᵢ and Yᵢ electrodes 53 and 54 but not between the Yᵢ and Xᵢ₊₁ electrodes. In addition, the M electrodes 56 may be placed only between the Yᵢ and Xᵢ₊₁ electrodes but not between the Xᵢ and Yᵢ electrodes. In such cases, the number of each of the X, Y, and M electrodes is equally n.

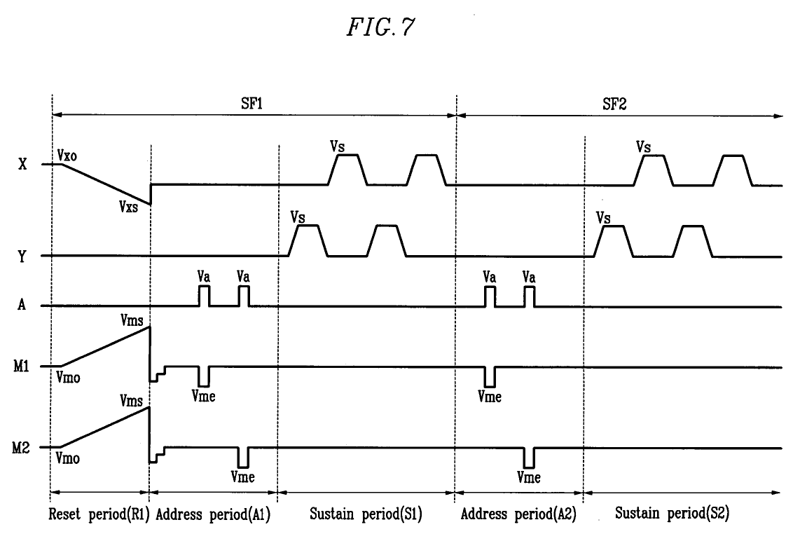

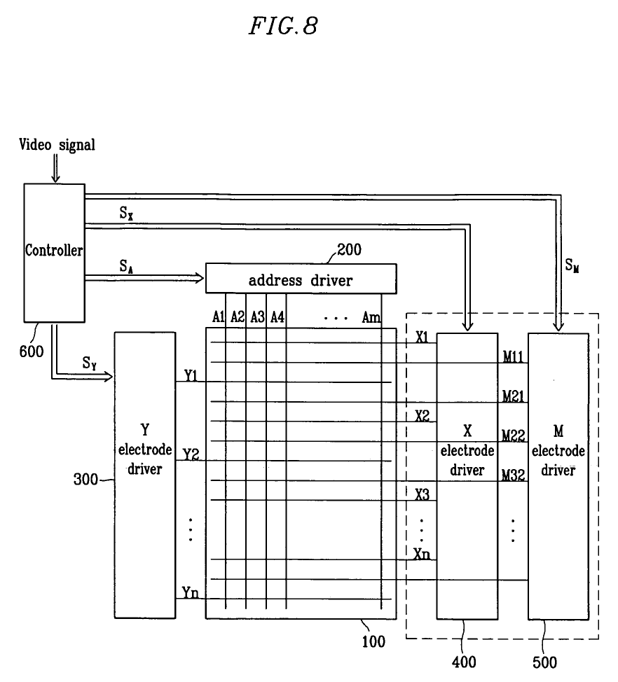

FIG. 6 and FIG. 7 illustrate a driving method for a PDP according to a first embodiment of the present invention.

Referring to FIG. 6, each frame is divided into eight subfields SF1-SF8 in order to realize time-division grayscale display. In FIG. 6, a first subfield SF1 is divided into a reset period R1, an address period A₁, and a sustain period S1, and subsequent subfields SF2-SF8 are respectively divided into address periods A2-A8 and sustain periods S2-S8. That is, according to the first embodiment of the present invention, only the first subfield in each frame chronologically has a reset period, and subsequent subfields do not have a reset period.

In the reset period R1 of the first subfield, a reset waveform is applied to every M electrode so as to change a wall charge state of every cell to the on state.

In each address period A1-A8, an erase address signal is applied to the address electrodes A₁-Aₘ, and at the same time, an erase scan pulse is sequentially applied to each M electrode M₁-Mₙ. As will be described later, a wall charge state is turned to the off state in a cell that is applied with the erase address pulse and the erase scan pulse, and accordingly, a discharge is not performed even when a sustain pulse is subsequently applied.

In each sustain period S1-S8, a sustain pulse is alternately applied to every Y electrode Y₁-Yₙ and to every X electrode X₁-Xₙ, and a display discharge is generated only at discharge cells (i.e., cells remaining in the on state) that are not applied with an erase address pulse during the address period A1-A8.

FIG. 7 illustrates driving waveforms applied to each electrode according to the first embodiment of the present invention. As shown in FIG. 7, according to a driving method of a first embodiment of the present invention, a sustain pulse is applied to X and Y electrodes throughout a whole period, and the M electrode receives a reset waveform and a scan pulse. As such, according to an embodiment of the present invention, only the sustain pulse is applied to the Y electrode, and the scan pulse or the reset waveform is not necessarily applied thereto. Therefore, a circuit of the Y electrode may be simplified in comparison with a conventional clear driving method. In addition, according to an embodiment of the present invention, the same sustain pulse is applied to the X and Y electrodes. Therefore, circuital impedance may be easily matched since the X and Y electrode driving circuits may be symmetrically designed.

In the driving method according to the first embodiment of the present invention, the first subfield includes a reset period, an address period, and a sustain period, and subsequent subfields include only the address period and the sustain period.

(1) Reset Period R1

In this period, wall charges for the on-state are carried out by discharging every cell by applying the reset waveform.

According to an embodiment of the present invention shown in FIG. 7, a ramp waveform rising from Vmo to Vms is applied to the M electrode such that negative wall charges are formed on the M electrode by generating a discharge between the M and X electrodes, between the M and Y electrodes, and between the M and A electrodes.

(2) Address Periods A1 and A2

In each address period, the erase scan pulse of an erase scan voltage Vme is sequentially applied to the M electrodes while biasing the M electrodes at a voltage Vmo. At the same time, an erase address voltage Va is applied to cells in which a discharge is not required, i.e., a cell to be turned off.

Then, a discharge is generated between the M electrode and the address electrode, and the discharge expands to the X and Y electrodes.

In this case, according to the first embodiment of the present invention, through the erase discharge between the M electrode and the address electrode, the wall charges of the on-state formed by the reset waveform are eliminated, and the wall charge state transitions to an off state.

(3) Sustain Discharge Periods S1 and S2

In a sustain discharge period of the first embodiment of the present invention, a pulse of a sustain discharge voltage Vs is alternately applied to the X and Y electrodes. By applying such a voltage, the sustain discharge is generated in all cells except the cells in which wall charges are eliminated during the address period.

FIG. 8 illustrates a PDP according to an embodiment of the present invention. As shown in FIG. 8, a plasma display device according to an embodiment of the present invention includes a PDP 100, an address driver 200, a Y electrode driver 300, an X electrode driver 400, an M electrode driver 500, and a controller 600.

The PDP 100 includes a plurality of address electrodes A₁ to Aₘ formed across the PDP 100 as a set of columns, and a plurality of Y electrodes, Y₁ to Yₙ, X electrodes, X₁ to Xₙ, and Mᵢⱼ electrodes formed across the PDP 100 as a set of rows. The Mᵢⱼ electrodes are electrodes formed between the Yᵢ electrodes and the Xⱼ electrodes.

The address driver 200 receives an address driving control signal S_{A} from the controller 600, and applies a display data signal selecting a discharge cell not to be displayed (i.e., an off-cell) to the respective address electrodes. The Y electrode driver 300 receives a Y electrode driving signal S_{Y} from the controller 600 and applies the waveform shown in FIG. 7 to the Y electrodes. The X electrode driver 400 receives an X electrode driving signal S_{X} from the controller 600, and applies the waveform shown in FIG. 7 to the X electrodes. The M electrode driver 500 receives an M electrode driving signal S_{M} from the controller 600, and applies the waveform shown in FIG. 7 to the M electrodes.

The controller 600 receives external video signals and generates the address driving control signal S_{A}, the Y electrode driving signal S_{Y}, the X electrode driving signal S_{X}, and the M electrode driving signal S_{M}.

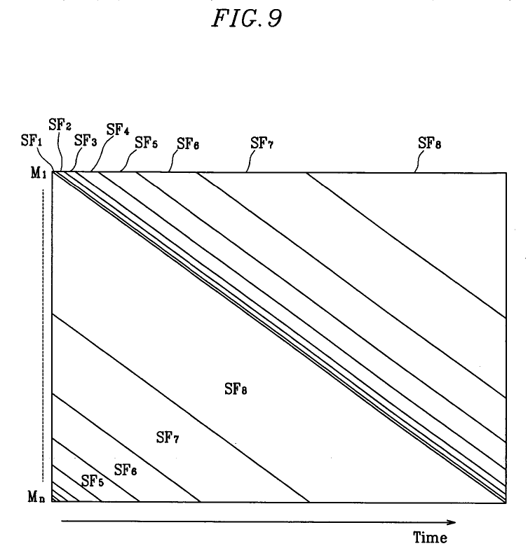

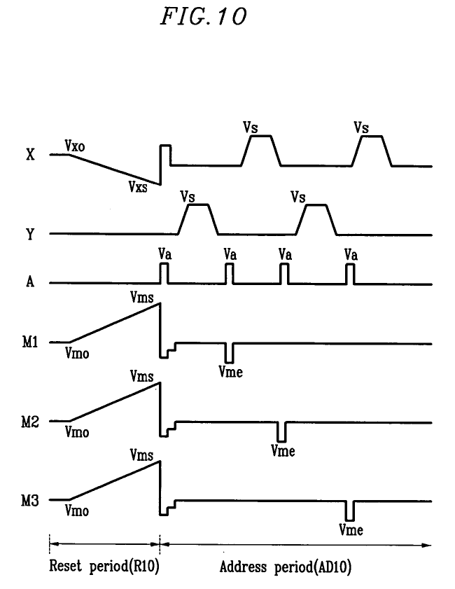

FIG. 9 and FIG. 10 illustrate a driving method of a PDP according to a second embodiment of the present invention.

Referring to FIG. 9, each frame is divided into eight subfields SF1-SF8 in order to implement a time-division grayscale display. Each subfield in the frame overlaps every other subfield with respect to the M electrodes M₁-Mₙ. Therefore, every subfield SF1-SF8 exists at any point in time. For example, at a given point in time, while an i-th M electrode has the erase scan pulse applied to it for addressing, a j-th M electrode has a sustain pulse applied to it. That is, addressing and display operations are simultaneously performed. The second embodiment of the present invention relates to a four electrode clear driving method realized by an address-while-display (AWD) scheme.

As shown in FIG. 10, according to a driving method of an embodiment of the present invention, a sustain pulse is applied to the X and Y electrodes throughout a the length of the address period, and the M electrode receives a reset waveform and a scan pulse. As such, according to the second embodiment of the present invention, only the sustain pulse is applied to the Y electrode. The scan pulse or the reset waveform is not necessarily applied to the Y electrode. Therefore, a circuit of the Y electrode may be simplified in comparison with a conventional clear driving method. According to the second embodiment of the present invention shown in FIG. 10, a reset period and an address-sustain period are included in a single frame.

A reset period R10 is included in every frame. In the reset period R10, the reset waveform is applied to cells so as to convert the cells receiving the reset waveform to an on-state.

In the address-sustain period, the sustain pulse is applied to the X and Y electrodes so as to initiate the sustain discharge in the on-cells, and at the same time, the address electrode and M electrode are selectively applied with the erase address voltage Va and the erase scan pulse Vme so as to convert the on-cells formed by the reset waveform to off-cells. In this case, according to the second embodiment of the present invention, the erase address pulse and the erase scan pulse are applied to the X and Y electrodes while the sustain pulse is not applied thereto. As described above, according to the second embodiment of the present invention, driving circuits for driving the X and Y electrodes may be designed in almost the same manner because the sustain pulse is alternately applied to the X and Y electrodes throughout the entire length of the period and the erase scan pulse is applied to the M electrode.

As described above, according to an embodiment of the present invention, since a reset waveform or an erase scan pulse is applied using a middle (M) electrode, enhancement of contrast and prevention of faulty discharge may be achieved at the same time.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a plasma display device including at least one first electrode and at least one second electrode for applying a sustain pulse, at least one third electrode formed running in a same direction as the first and second electrodes, and at least one fourth electrode crossing the at least one first, second, and third electrodes, the driving method comprising:
applying a reset waveform to the at least one third electrode during a first period, the reset waveform converting each discharge cell to an on-state;
performing an address operation by selectively applying a first pulse and a second pulse to the third electrode and the at least one fourth electrode, for converting an on-cell formed by the reset waveform to an off-cell; and
performing a sustain discharge operation to on-cells by applying a sustain pulse to the at least one first and the at least one second electrodes.

2. The driving method of claim 1, wherein the plasma display device is driven by a frame including a plurality of subfields, and a first period is included in only one subfield among the plurality of subfields.

3. The driving method of claim 1, wherein the plasma display device is driven by a frame including a plurality of subfields, and a first period is a part of a chronologically first subfield among the plurality of subfields in the frame.

4. The driving method of claim 1, wherein the performing of the address operation and the performing of the sustain discharge operation are done in separated periods for each cell.

5. The driving method of claim 1, wherein the at least one first electrode, the at least one second electrode, the at least one third electrode, and the at least one fourth electrode are respectively provided as a group, wherein a discharge cell is formed by the at least one first, second, third, and fourth electrodes corresponding to each other; and
while an address operation is performed in a j-th discharge cell by applying a first pulse to the at least one third electrode of the j-th discharge cell, a sustain operation is performed in an m-th discharge cell by applying a sustain pulse to one of the at least one first and at least one second electrode of the m-th discharge cell.

6. The driving method of claim 5, wherein the first pulse is applied between periods for applying the sustain pulse to the at least one first electrode and the at least one second electrode.

7. The driving method of claim 1, wherein the at least one third electrode is formed between the first electrode and the second electrode.

8. A driving method of a plasma display device including at least one first electrode and at least one second electrode each applied with a sustain pulse, at least one third electrode formed in the same direction as the first and second electrodes, and at least one fourth electrode crossing the first, second, and third electrodes,
the plasma display device being driven by a frame including a plurality of subfields including first and second subfields, the driving method comprising:
in the first subfield,
applying a reset waveform to the at least one third electrode during a first period, the reset waveform converting every cell to an on state;
performing an address operation by selectively applying a first pulse and a second pulse to the third electrode and the fourth electrode, for converting an on-cell formed by the reset waveform to an off-cell; and
performing a sustain discharge operation on cells not applied with the first and second pulses, by applying a sustain pulse to the first and the second electrodes,
and in the second subfield,
performing an address operation by selectively applying the first and second pulses to the third and fourth electrodes, for converting an on-cell formed by the reset waveform to an off-cell; and
performing a sustain discharge operation at cells not applied with the first and second pulses, by applying a sustain pulse to the at least one first and the second electrodes.

9. The driving method claim 8, wherein, in the first subfield, the performing of the address operation and the performing of the sustain discharge operation are done in separated periods for each cell.

10. The driving method claim 8, wherein the at least one first electrode, the at least one second electrode, the at least one third electrode, and the at least one fourth electrode are respectively provided as a plurality, wherein a discharge cell is formed by the at least one first, second, third, and fourth electrodes corresponding to each other; and
while an address operation is performed in a j-th discharge cell by applying a first pulse to the third electrode of the j-th discharge cell, a sustain operation is performed in an m-th discharge cell by applying a sustain pulse to one of the at least one first and second electrodes of the m-th discharge cell.

11. A plasma display device comprising:
a plasma display panel including X and Y electrodes for applying a sustain discharge voltage pulse, an M electrode formed running in a same direction as the X and Y electrodes, and an address electrode insulated from and crossing the X, Y, and M electrodes;
an address driver for applying a display data signal for turning off a discharge cell to the address electrode;
an X electrode driver and a Y electrode driver for applying a sustain discharge voltage pulse and for performing a sustain discharge to the X and Y electrodes;
an M electrode driver for applying a reset waveform for enabling an on state of each cell to the M electrode; and
a controller for supplying a control signal to the address driver, the X electrode driver, the Y electrode driver, and the M electrode driver.

12. The plasma display device of claim 11, wherein the M electrode driver applies an erase scan pulse for converting a cell from the on state to an off state.

13. The plasma display device of claim 12, wherein the M electrode driver applies the reset waveform for enabling the on state of each cell during the first period; and
the address driver and the M electrode driver selectively apply an erase address pulse and the erase scan pulse to the address electrode and the M electrode for converting an on-cell formed by the reset waveform to an off-cell.

14. The plasma display device of claim 13, wherein the plasma display device is driven by a frame including a plurality of subfields, and a first period is a part of a chronologically first subfield among the plurality of subfields.
